(19) United States
(12) Patent Application Publication
(10) Pub. No.: US 2025/0220780 A1
(43) Pub. Date: Jul. 3, 2025

(54) ELECTRIC HEATING ASSEMBLY AND MOISTURE MITIGATION FOR THE SAME

(71) Applicant: Haier US Appliance Solutions, Inc., Wilmington, DE (US)

(72) Inventor: Stephen Bernard Froelicher, Shepherdsville, KY (US)

(21) Appl. No.: 18/403,289

(22) Filed: Jan. 3, 2024

(51) Int. Cl. H05B 3/46; H05B 3/02; H05B 3/44

(52) U.S. Cl. CPC H05B 3/46; H05B 3/02; H05B 3/44; H05B 2203/002

(57) ABSTRACT

An electric heating assembly may include a sheath, a resistive wire, a thermally conductive electrical insulation, and a tubular body. The sheath may define an enclosed volume along a longitudinal length between a first end portion and a second end portion. The resistive wire may be disposed within the enclosed volume to generate heat in response to an electrical current. The thermally conductive electrical insulation may be radially positioned between the resistive wire and the sheath. The tubular body may be disposed radially inward from the sheath and define a vent channel extending from a vent inlet disposed within the sheath to a vent outlet held outside of the sheath.

### FIELD OF THE DISCLOSURE

The present subject matter relates generally to electric heating assemblies, such as for oven or cooktop appliances, and more particularly to features for mitigating moisture at an electric heating assembly.

### BACKGROUND OF THE DISCLOSURE

Electric heating elements, such as CALROD® heaters, are used in a variety of contexts. In particular, one or more resistive element may be provided for safely and cleanly generating heat in a variety of contexts. One of these contexts is within an oven appliance or cooktop appliance, wherein an electric element may be used to heat food items or utensils within the oven appliance or on top of the cooktop. For instance, electric heating elements are often positioned within the cooking chamber of an oven appliance to provide heat to food items located therein. The heating elements can include a bake heating element positioned at the bottom of the cooking chamber or a broil heating element positioned at the top of the cooking chamber. Oven appliances may also include a convection heating assembly, which may include a convection heating element and fan or other mechanism for creating a flow of heated air within the cooking chamber.

Over time, it is possible for moisture to accumulate or settle within a electric heating element. This is especially true after extended periods of non-use. At relatively low levels, this moisture may be evaporated and driven out of the resistive heating element without issue. Significant moisture buildup (e.g., such as might occur in a vacation property or appliance that is not used for multiple weeks or months), however, can cause problems. For instance, rapid heating of moisture within the electric heating element may cause a current leakage or may otherwise disrupt an electrical current at the heating element. This may, in turn, create difficulties with operation of the heating element or safety monitoring of the heating element.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, an electric heating assembly for a consumer appliance is provided. The electric heating assembly may include a sheath, a resistive wire, a thermally conductive electrical insulation, and a tubular body. The sheath may define an enclosed volume along a longitudinal length between a first end portion and a second end portion. The resistive wire may be disposed within the enclosed volume to generate heat in response to an electrical current. The thermally conductive electrical insulation may be radially positioned between the resistive wire and the sheath. The tubular body may be disposed radially inward from the sheath and define a vent channel extending from a vent inlet disposed within the sheath to a vent outlet held outside of the sheath.

In another exemplary aspect of the present disclosure, an oven appliance is provided. The oven appliance may include a cabinet and an electric heating assembly. The cabinet may define a cooking chamber for receiving food items for cooking. The electric heating assembly may be mounted within the cabinet. The electric heating assembly may include a sheath, a resistive wire, a thermally conductive electrical insulation, and a tubular body. The sheath may define an enclosed volume along a longitudinal length between a first end portion and a second end portion. The resistive wire may be disposed within the enclosed volume to generate heat in response to an electrical current. The thermally conductive electrical insulation may be radially positioned between the resistive wire and the sheath. The tubular body may be disposed radially inward from the sheath and define a vent channel extending from a vent inlet disposed within the sheath to a vent outlet held outside of the sheath.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a cooking appliance according to exemplary embodiments of the present disclosure.

FIG. 2 provides a cross-sectional side view of the exemplary oven appliance of FIG. 1 along the line 2-2.

FIG. 3 provides a section view of a resistive heating element according to exemplary embodiments of the present disclosure.

FIG. 4 provides a schematic section view of a heating assembly according to exemplary embodiments of the present disclosure.

FIG. 5 provides a simplified section view of a portion of a resistive heating element according to exemplary embodiments of the present disclosure.

FIG. 6 provides a sectional perspective view of a portion of a resistive heating element according to exemplary embodiments of the present disclosure.

FIG. 7A provides a sectional side perspective view of the exemplary resistive heating element of FIG. 6.

FIG. 7B provides a side perspective view of a portion of the exemplary resistive heating element of FIG. 6.

FIG. 8 provides a cross-sectional, side perspective view of a portion of a tubular body, during assembly, of a resistive heating element according to exemplary embodiments of the present disclosure.

FIG. 9 provides a cross-sectional, side perspective view of a portion of a tubular body, during assembly, of a resistive heating element according to exemplary embodiments of the present disclosure.

FIG. 10 provides a cross-sectional, side perspective view of a portion of a tubular body, during assembly, of a resistive heating element according to exemplary embodiments of the present disclosure.

FIG. 11 provides a cross-sectional, side perspective view of a portion of a tubular body, during assembly, of a resistive heating element according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Generally, it may be advantageous to provide an appliance or assembly with one or more features for managing or responding to moisture driven from an electric heating element (e.g., without halting operation or safety monitoring thereof). Additionally or alternatively, it may be advantageous to provide an electric heating element (or features for the same) capable of venting moisture from the electric heating element (e.g., without significantly increasing the required diameter, size, or shape of the electric heating element to satisfy safety standards, such as a minimum radial distance between resistive wire and a sheath).

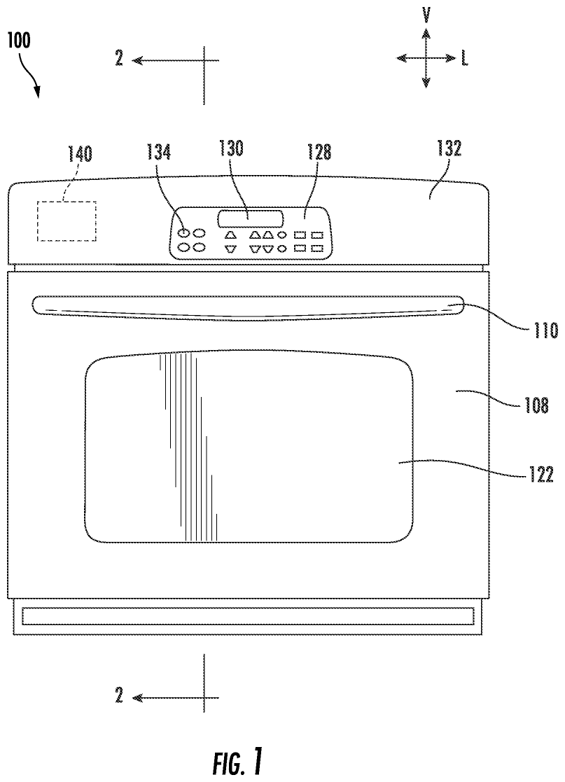

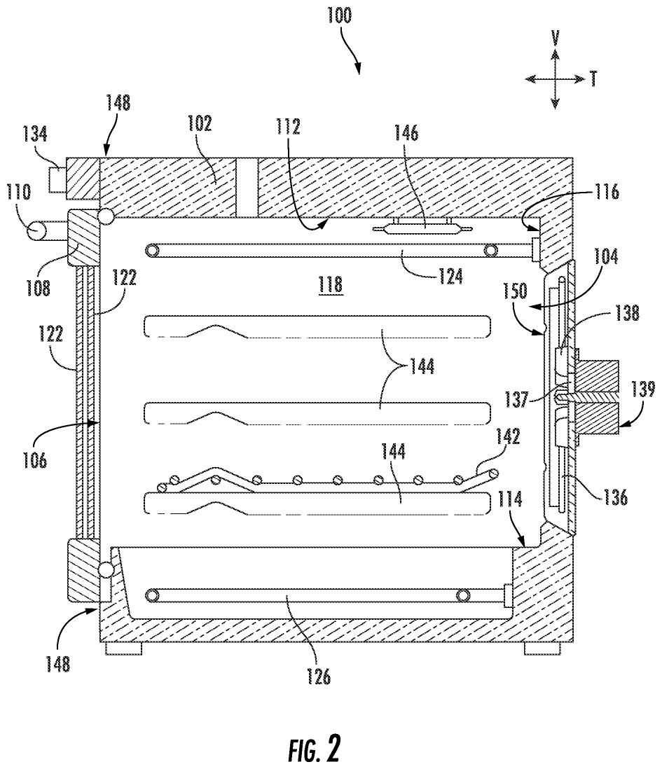

Referring to FIGS. 1 and 2, in exemplary embodiments, a cooking appliance or oven appliance 100 that includes an insulated cabinet 102 with an interior cooking chamber 104 defined by a plurality of inner walls (e.g., a top wall 112, a bottom wall 114, a back wall 116, and opposing sidewalls 118, 120). Cooking chamber 104 is configured for the receipt of one or more food items to be cooked. Oven appliance 100 includes a door 108 pivotally mounted, for example, with one or more hinges (not shown), to cabinet 102 at the opening 106 of cabinet 102 to permit selective access to cooking chamber 104 through opening 106. A handle 110 is mounted to door 108 and assists a user with opening and closing door 108. For example, a user can pull on handle 110 to open or close door 108 and access cooking chamber 104.

In some embodiments, a seal (e.g., gasket) is provided between door 108 and cabinet 102 that assists with maintaining heat and cooking fumes within cooking chamber 104 when door 108 is closed, as shown in FIGS. 1 and 2. Multiple parallel glass panes 122 provide for viewing the contents of cooking chamber 104 when door 108 is closed and assist with insulating cooking chamber 104. A baking rack 142 is positioned in cooking chamber 104 for the receipt of food items or utensils containing food items. Baking rack 142 is slidably received onto embossed ribs or sliding rails 144 such that rack 142 may be conveniently moved into and out of cooking chamber 104 when door 108 is open.

A heating element at the top, bottom, or both of cooking chamber 104 provides heat to cooking chamber 104 for cooking. Such heating element(s) can be gas, electric, microwave, or a combination thereof. For example, in the embodiment shown in FIG. 2, oven appliance 100 includes a top heating element 124 and a bottom heating element 126, where bottom heating element 126 is positioned adjacent to and below bottom wall 114. Other configurations with or without wall 114 may be used as well.

In some embodiments, oven appliance 100 includes a convection heating element 136 or convection fan 138 positioned adjacent back wall 116 of cooking chamber 104 (e.g., in fluid communication with cooking chamber 104 through a fan opening 150), which may be powered by a convection fan motor 139.

As shown, oven appliance 100 includes a user interface 128. In some embodiments, user interface 128 has a display 130 positioned on an interface panel 132, as well as a variety of controls 134. Interface 128 allows the user to select various options for the operation of oven 100 including, for example, temperature, time, and various cooking or cleaning cycles. Operation of oven appliance 100 can be regulated by a controller 140 that is operatively coupled (i.e., in communication with) user interface 128, heating elements 124, 126, 136, and other suitable components of oven 100.

In certain embodiments, in response to user manipulation of the user interface 128, controller 140 can operate the heating element(s). Controller 140 can receive measurements from a temperature sensor 146 placed in cooking chamber 104 and, optionally, provide a temperature indication to the user with display 130.

In some embodiments, controller 140 includes a memory (e.g., non-transitive media) and one or more processing devices such as microprocessors, CPUs, or the like, such as general or special purpose microprocessors operable to execute programming instructions or micro-control code associated with operation of oven appliance 100. The memory may represent random access memory such as DRAM or read only memory such as ROM or FLASH. In one embodiment, the processor executes programming instructions stored in memory. The memory may be a separate component from the processor or may be included onboard within the processor.

Controller 140 may be positioned in a variety of locations throughout oven appliance 100. In the illustrated embodiment, controller 140 is located next to user interface 128 within interface panel 132. In other embodiments, controller 140 may be located under or next to the user interface 128 otherwise within interface panel 132 or at any other appropriate location with respect to oven appliance 100. In the embodiment illustrated in FIG. 1, input/output (“I/O”) signals are routed between controller 140 and various operational components of oven appliance 100 such as heating elements 124, 126, 136, convection fan 138, controls 134, display 130, sensor 146, alarms, or other components as may be provided. In one embodiment, user interface 128 may represent a general purpose I/O (“GPIO”) device or functional block.

Although shown with touch type controls 134, it should be understood that controls 134 and the configuration of oven appliance 100 shown in FIG. 1 is provided by way of example only. User interface 128 may include various input components, such as one or more of a variety of electrical, mechanical, or electro-mechanical input devices including rotary dials, push buttons, and touch pads. User interface 128 may include other display components, such as a digital or analog display device designed to provide operational feedback to a user. User interface 128 may be in communication with controller 140 via one or more signal lines or shared communication busses.

While oven 100 is shown as a wall oven, the present invention could also be used with other cooking appliances or configurations such as, for example, a double-chamber oven appliance, a stand-alone oven appliance, a combined oven-range appliance, cooktop appliance, or any other suitable appliance including one or more heating elements, as would be understood in light of the present disclosure.

Turning now generally to FIGS. 3 through 11, various views are provided of an electric heater or heating assembly 302 (or portions thereof) according to exemplary embodiments of the present disclosure. As would be understood in light of the present disclosure, electric heating assembly 302 may be included as or as part of any one of heating elements 124, 126, 136, described above in the context of oven appliance 100.

As shown, for instance in FIG. 3, electric heating element or heater 302 includes a conductive sheath 304 that extends along a longitudinal length between a first end 306A and a second end 306B. Specifically, electrical heater 302, including conductive sheath 304 may extend longitudinally along a central axis A between first end 306A and second end 306B. Although shown as a generally straight member, it is understood that heater 302 may be formed into any suitable shape. For example, heater 302 may generally be U-shaped, circular, arcuate, have multiple coils, etc.

Conductive sheath 304 is formed as a generally solid or non-permeable metal structure that does not permit the passage of liquids, such as water. Conductive sheath 304 may be constructed of or with a suitable thermally conductive metal material. For example, conductive sheath 304 may be constructed of steel, aluminum (including alloys of steel or aluminum). In some embodiments, conductive sheath 304 defines an enclosed volume 310. As shown, enclosed volume 310 may be defined along the longitudinal length from first end 306A to second end 306B.

In some embodiments, one or more end caps 320A, 320B are disposed at the ends 306A, 306B of conductive sheath 304. Each end cap 320A and 320B may be formed from any suitable insulating material to limit or restrict conducted heat and/or electricity from passing from conductive sheath 304 (e.g., silicone rubber) through end cap 320A or 320B. In some embodiments, a first end cap 320A is disposed at the first end 306A of conductive sheath 304. In additional embodiments, a second end cap 320B is disposed at the second end 306B of conductive sheath 304.

Separate from or in tandem with an end cap 320A or 320B, a grounding plate 312 may be provided proximate to at least one end 306A or 306B. For instance, grounding plate 312 may extend radially (e.g., outward) from conductive sheath 304. Moreover, grounding plate 312 may be disposed in conductive communication with conductive sheath 304. In some embodiments, a friction fit or crimping joint may secure grounding plate 312 to conductive sheath 304 or heating assembly 302 generally.

Generally, a resistive heating element 326 is disposed within the heater 302. Specifically, resistive heating element 326 is disposed within the enclosed volume 310 of conductive sheath 304 to generate heat in response to an electrical current. When assembled, resistive heating element 326 may be electrically coupled to a voltage source (not pictured) or controller 140 through a lead wire extending from end cap(s) 320A, 320B. In some embodiments, resistive heating element 326 includes or is provided as a resistive wire 328 formed from a suitable high-resistance material, such as nichrome (i.e., a nickel-chromium alloy), ferrochrome (i.e., an iron-chromium alloy), etc.

Resistive element 326 may be coupled to terminals 350 at opposite ends of resistive element 326. In some such embodiments, a discrete cold pin 330A or 330B may be provided at first and second ends 306A, 306B of electrical heater 302. In particular, a first end cold pin 330A is in electrical communication (e.g., direct or indirect conductive communication) with resistive element 326 at first end 306A, and a second end cold pin 330B is in electrical communication (e.g., direct or indirect conductive communication) with resistive element 326 at second end 306B. Both cold pins 330A, 330B may be positioned radially inward from sheath 304 (e.g., at least partially within enclosed volume 310). For instance, each cold pin 330A, 330B may extend from a corresponding terminal internal end 314 disposed within the sheath 304 or enclosed volume 310 to a terminal external end 316 held outside of sheath 304 or enclosed volume 310. A corresponding a terminal 350 may be attached to terminal external end 316 while the terminal internal end 314 may be proximal to or in contact with resistive element 326. When assembled, each cold pin 330A, 330B may be joined (e.g., bonded or welded) to resistive element 326 (e.g., as will be described in greater detail below). Additionally or alternatively, each cold pin 330A, 330B may be formed from a conductive metal have a lower electrical resistance than the resistive element 326. During use (e.g., active heating operations), a voltage applied across terminals 350 may pass between the cold pins 330A, 330B and resistive element 326, inducing a current within resistive element 326 that in turn causes resistive element 326 to increase in temperature.

In some embodiments, conductive sheath 304 is packed with a thermally conductive electrical insulation 334, such as magnesium dioxide or vitrified magnesite. Specifically, thermally conductive electrical insulation 334 may be radially positioned between resistive heating element 326 and conductive sheath 304. In turn, thermally conductive electrical insulation 334 may separate resistive heating element 326 and conductive sheath 304 along a radial direction R defined from resistive heating element 326. During operation of heater 302, thermally conductive electrical insulation 334 may prevent electrical conduction between resistive heating element 326 and conductive sheath 304, while permitting heat conduction therethrough.

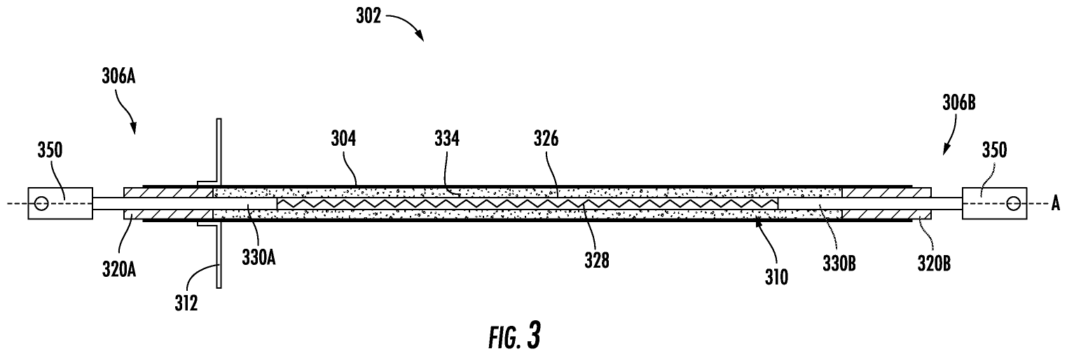

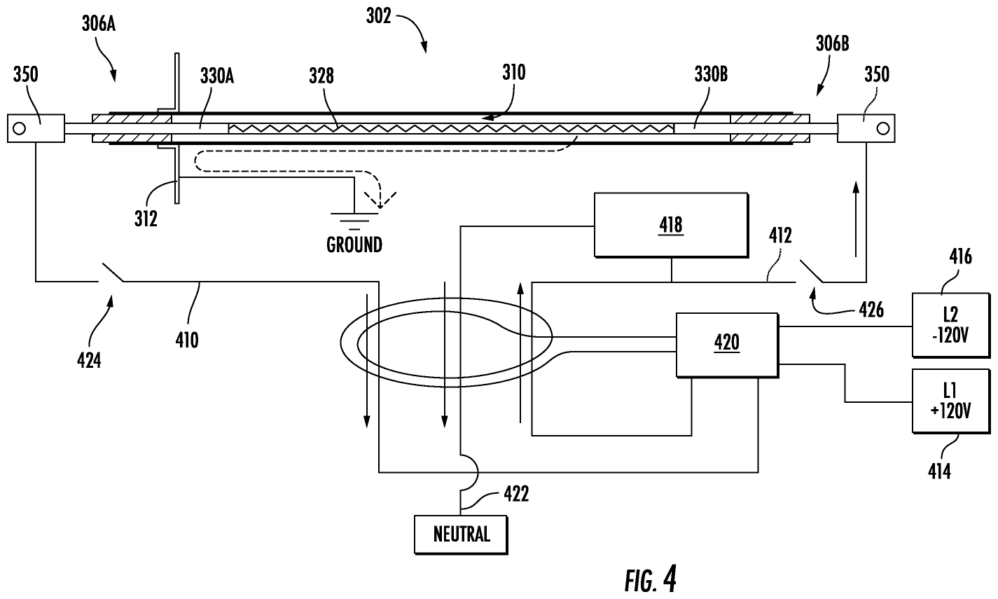

Turning now especially to FIG. 4, multiple voltage supply lines 410, 412 may connect heater 302 to one or more voltage sources 414, 416. In particular, a pair of voltage supply lines 410, 412 may be connected (e.g., electrically connected) to heater 302 at opposite end portions (e.g., 306A and 306B). Thus, a first voltage supply line 410 may connect to heater 302 at first end 306A (e.g., via a terminal 350 corresponding to or disposed at first end 306A) while a second voltage supply line 412 connects to heater 302 at second end 306B (e.g., via a terminal 350 corresponding to or disposed at second end 306B).

Generally, the supply lines 410, 412, and thus heater 302, connect to one or more voltage sources 414, 416 configured to supply an electrical current to through the supply lines 410, 412 and to the heater 302. In some embodiments, two or more voltage sources 414, 416 are connected (e.g., electrically connected) to the supply lines 410, 412. Specifically, a first voltage source 414 may connect to first voltage supply line 410 (e.g., in series with the terminal 350 at the first end 306A). Moreover, a second voltage source 416 may connect to second voltage supply line 412 (e.g., in series with the terminal 350 at the second end 306B). In turn, the first voltage source 414 may be understood to be proximal to the first end 306A (e.g., according to electrical communication such that the first voltage source 414 is distal to the second end 306B) while the second voltage source 416 is understood to be proximal to the second end 306B (e.g., according to electrical communication such that the second voltage source 416 is distal to the first end 306A).

Optionally, one or more additional appliance components 418 (e.g., light diodes, displays, etc.) may be connected to only one of the voltage sources 414, 416 (e.g., second voltage source 416), such as between the connected voltage source (e.g., 416) and a neutral line 422. In turn, such components 418 may only receive an electrical current from one of the pair of voltage sources 414, 416.

The voltage sources 414, 416 may be set at inverse phases (e.g., such that the phases of currents from the sources 414, 416 may be inverse from each other). Thus, the first voltage source 414 may be set according to one phase (e.g., positive) while the second voltage source 416 may be set according to an opposite phase (e.g., negative) such that currents therefrom may alternate. The absolute value of the voltage of the currents supplied from the voltage sources 414, 416 may be configured as any suitable voltage (e.g., the same absolute value). Optionally, the first voltage source 414 is set at approximately 120 Volts (i.e., between 103 Volts and 130 Volts) while the second voltage source 416 is set at approximately 120 Volts. During operation, when the current from the first voltage source 414 is supplied at (+) 120 V, the current from the second voltage source 416 may be supplied at (−) 120 V.

In optional embodiments, a ground fault circuit interrupter (GFCI) 420 is provided along one or both of the voltage supply lines 410, 412. For instance, the GFCI 420 may connect to and be disposed along the first voltage supply line 410 and the second voltage supply line 412. As would be understood, the GFCI 420 may include a sensor configured to monitor for (i.e., detect) current leakages (e.g., as measured in Amperes) through one or more lines, such as first voltage supply line 410, second voltage supply line 412, or neutral line 422. In particular, the GFCI 420 may be configured or set to detect imbalances in a current through the monitored lines 410, 412, or 422 (e.g., according to a predetermined imbalance value). Detection of an imbalance value above the predetermined imbalance value may thus cause the GFCI 420 to trip, thus opening the circuit to first voltage supply line 410 or second voltage supply line 412.

In some embodiments, one or more switching elements 424, 426 are provided along one or more of the supply lines 410, 412 to selectively restrict currents from one or more of the voltage sources 414, 416 (e.g., separate from or in addition to the GFCI 420). In certain embodiments, discrete switching elements 424, 426 are provided for each voltage supply line 410 and 412. For instance, a first switching element 424 may be disposed along the first voltage supply line 410 to selectively restrict a current from the first voltage source 414. During use, supply of the current from the first voltage source 414 to the terminal 350 at the first end 306A may be controlled or determined according to the position (e.g., open or close) of the first switching element 424. Additionally or alternatively, a second switching element 426 may be disposed along the second voltage supply line 412 to selectively restrict a current from the second voltage source 416. During use, supply of the current from the second voltage source 416 to the terminal 350 at the second end 306B may be controlled or determined according to the position (e.g., open or close) of the first switching element 424.

As would be understood, the switching elements 424, 426 may include any suitable switch or relay configured to selectively open-close or otherwise limit current flow along a corresponding line. Such switching elements 424, 426 may be in operative (e.g., electrical or wireless communication) communication with the controller 140, which may in turn be configured to direct (e.g., open-close or restrict current therethrough) the switching elements 424, 426. In some embodiments, the controller 140 may further be configured to control the first and second switching elements 424, 426 according to a selected heating cycle [e.g., specifying a desired temperature or heating profile for the heater 302 or cooking chamber 104 (FIG. 2), generally].

In optional embodiments, the controller 140 is configured to control the switching elements 424, 426 in tandem (e.g., for general operation or for specific selectable heating cycles). Thus, the controller 140 may be configured to simultaneously open both switching elements 424, 426 and simultaneously close both switching elements 424, 426. During such use, the first switching element 424 may thus be opened or directed to open when the second switching element 426 is opened or directed to open, and vice versa. Moreover, the first switching element 424 may be closed or directed to close when the second switching element 426 is closed or directed to close, and vice versa. Notably, inverse-phase currents from the voltage sources 414, 416 may be used to prevent sudden spikes in current leak or imbalance (e.g., which might otherwise trip a GFCI 420).

Turning now generally to FIGS. 5 through 8, electric heating assembly 302 may provide one or more vent channels 428 to permit the venting or expulsion of water, water vapor, or one or more gases from the enclosed volume 310 defined by the sheath 304. Specifically, a radially covered vent channel 428 may be defined by a tubular body 430 to extend from the thermally conductive electrical insulation in fluid communication with an area (e.g., ambient environment) outside of the sheath 304. As will be described in greater detail below, the vent channel(s) 428 may be defined proximal to the end portions (e.g., closer to a corresponding end portions longitudinally or along the axial length than a center point of the length). During active operation of the electric heating assembly 302, any collected water or moisture within the enclosed volume 310 may be excited or vaporized as it is driven toward one or more of the end portions and through a vent channel 428. Notably, sudden spikes in current leak or imbalances that might otherwise be caused by the driven water or moisture (e.g., water vapor) may be prevented or mitigated as such water or moisture is permitted to evaporate to the area outside of the sheath 304.

It is noted that although FIGS. 5 through 8 only depict a single end portion having a vent channel 428 proximal thereto (and thus distal to the opposite end portion), exemplary embodiments include similar vent channels 428 proximal to the opposite end portion. Thus, envisioned embodiments include both a first vent channel 428 disposed proximal to the first end 306A, as well as a second vent channel 428 that is defined proximal to the second end 306B.

Turning especially to FIGS. 5, 6, 7A, and 7B, the sheath 304 may define an axial opening 432 (e.g., covered in part by a corresponding end cap 320) at the end portion. In certain embodiments, the tubular body 430 extends through the axial opening 432 or end cap 320. For instance, the tubular body 430 may extend axially (e.g., longitudinally) at the corresponding end portion from the enclosed volume 310 to the area outside of the sheath 304. Specifically, the tubular body 430 may extend along the axial length between the terminal internal end 314, which is disposed within the sheath 304 or enclosed volume 310, and the terminal external end 316, which is held outside of sheath 304 or enclosed volume 310. The sheath 304 itself may be provided a solid, non-permeable member through which no radial openings are defined or water permitted. Optionally, the tubular body 430 may include or be provided as a cold pin 330. As noted above, the cold pin 330 may be connected to or in contact with the resistive wire 328.

As shown, the tubular body 430 may define the vent channel 428, including a vent outlet 434. The vent outlet 434, and thus the portion of tubular body 430 defining the same, may be held outside of the enclosed volume 310 apart from sheath 304. By contrast, a vent inlet 436, and thus the portion of tubular body 430 defining the same, may be held within the enclosed volume 310 in sheath 304. Optionally, the vent inlet 436 may extend or be defined radially (e.g., perpendicular to the axial direction A) or in a generally radial direction that is non-parallel to the axial direction A. In some such embodiments, the tubular body 430 defines one or more (e.g., a plurality of) radial entry passages 452 in fluid communication with the longitudinal passage 438. Such radial entry passages 452 may be included with or provide the vent inlet 436. In certain embodiments, the vent inlet 436 is defined proximal to the terminal internal end 314 (i.e., distal to the terminal external end 316) relative to the axial direction A. Thus, as tracked or measured along the axial direction A, the vent inlet 436 may be disposed closer to the terminal internal end 314 than the terminal external end 316.

An axial or longitudinal passage 438 may be defined within the tubular body 430 (e.g., parallel to the axial direction A). The longitudinal passage 438 may define an axial channel length, such as between the vent inlet 436 and the vent outlet 434. The axial channel length may be between approximately 0.5 inches and approximately 15 inches. For instance the axial channel length may be approximately 3.0 inches.

When assembled, the longitudinal passage 438 may be in fluid communication between the vent inlet 436 and vent outlet 434 as at least a portion of vent channel 428. During use, such as active heating operations at the heater 302, liquid or vapor water captured within the heater 302 may be excited and propelled as water vapor through the vent channel 428 (e.g., as illustrated by the arrows flowing from vent channel 428 in FIG. 5).

Generally, the vent channel 428 defines a minimum radial diameter or cross-section (e.g., diameter perpendicular to the direction of driven water or moisture flow—which may include or be provided as the equivalent hydraulic diameter) sufficient to permit the flow of driven water or moisture therethrough. In optional embodiments, the vent channel defines a minimum cross-section or equivalent hydraulic diameter between approximately 0.01 inches and approximately 0.1 inches. In additional or alternative embodiments, the vent channel defines a minimum cross-section or equivalent hydraulic diameter greater than 0.01 inches. In further additional or alternative embodiments, the vent channel defines a minimum cross-section or equivalent hydraulic diameter less than 0.08 inches. In still further additional or alternative embodiments, the vent channel defines a minimum cross-section or equivalent hydraulic diameter that is approximately 0.03 inches.

Generally, the vent channel 428 defines a channel ratio of the axial channel length 454 over the radial diameter or minimum cross-section. In some embodiments, the channel ratio is between 50 and 1500, such that venting is permitted without significant risk of moisture ingress (e.g., from the vent outlet 434 to the vent inlet 436). Additionally or alternatively, migration of the electrical insulation 334 to the vent channel 428 may notably be prevented.

In certain embodiments, a solid tip 440 is formed on the tubular body 430. Specifically, the solid tip 440 may be formed across longitudinal passage 438 (e.g., at least partially blocking the same). The solid tip 440 may be disposed or held within the enclosed volume 310 or sheath 304 (e.g., apart from the outlet). The resistive wire 328 may contact the tubular body 430 at the solid tip 440. Specifically, the resistive wire 328 may exclusively contact the tubular body 430 at the solid tip 440 without reaching or covering an expanded or straight portion of the tubular body 430 or at a portion of the tubular body 430 otherwise defining a maximum outer diameter of the tubular body 430 within the enclosed volume 310. Additionally or alternatively, the solid tip 440 may be tapered or conical such that a diameter of the solid tip 440 reduces inwardly along the length of the assembly (e.g., from a shelf, nose, or maximum radial diameter of tubular body 430). In other words, the solid tip 440 may be tapered such that it narrows away from the vent channel 428 (e.g., opposite the direction of moisture flow along the longitudinal passage 438, the vent inlet 436 outlet 434, or the vent inlet 436). Notably, regulatory minimum distances (e.g., between resistive wire 328 and sheath 304) may be maintained without requiring significant expansion of the enclosed volume 310 and sheath 304 (e.g., while maintaining the volume required for vent channel 328).

It is noted that although a conical solid tip 440 is illustrated in the figures, alternative embodiments may include a solid tip having a continuous round, elliptical, or polygonal cross-sectional profile (e.g., perpendicular to the axial direction A). Additionally or alternatively, the tubular body 430 may be include or otherwise define a round, elliptical, or polygonal cross-sectional profile (e.g., perpendicular to the axial direction A).

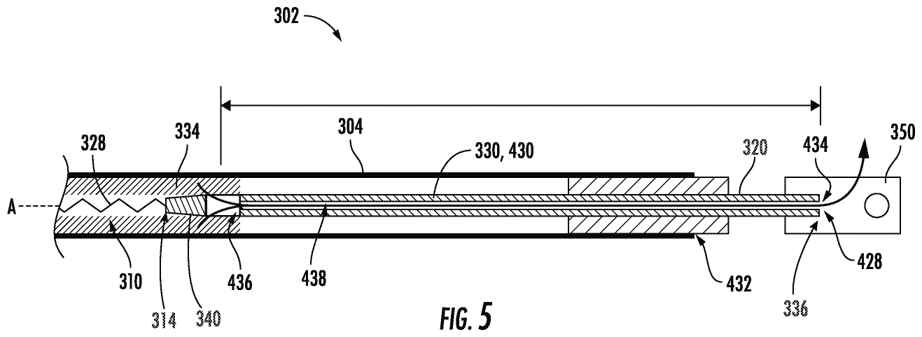

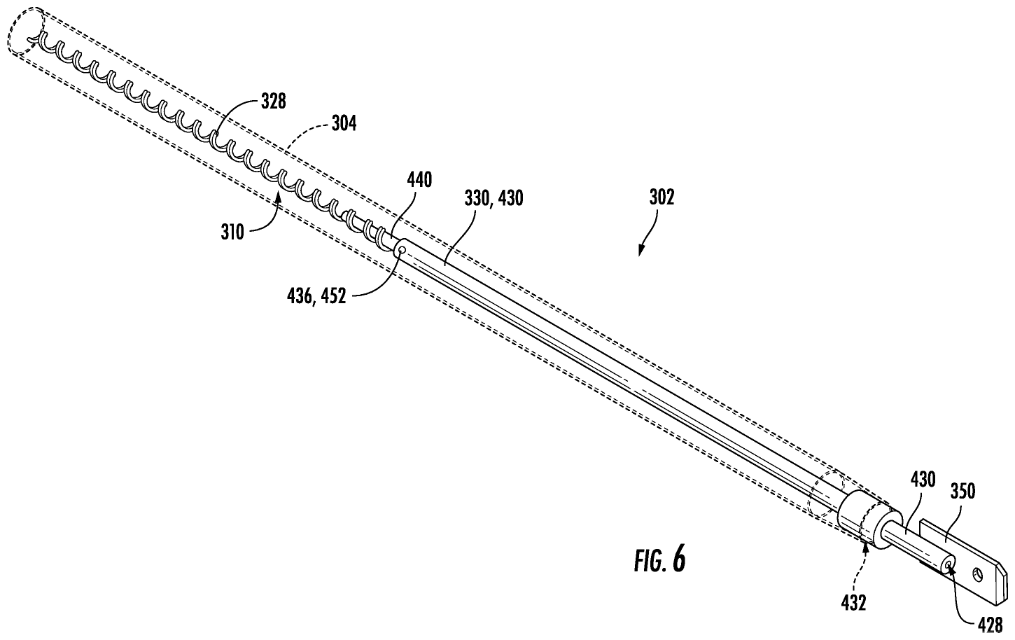

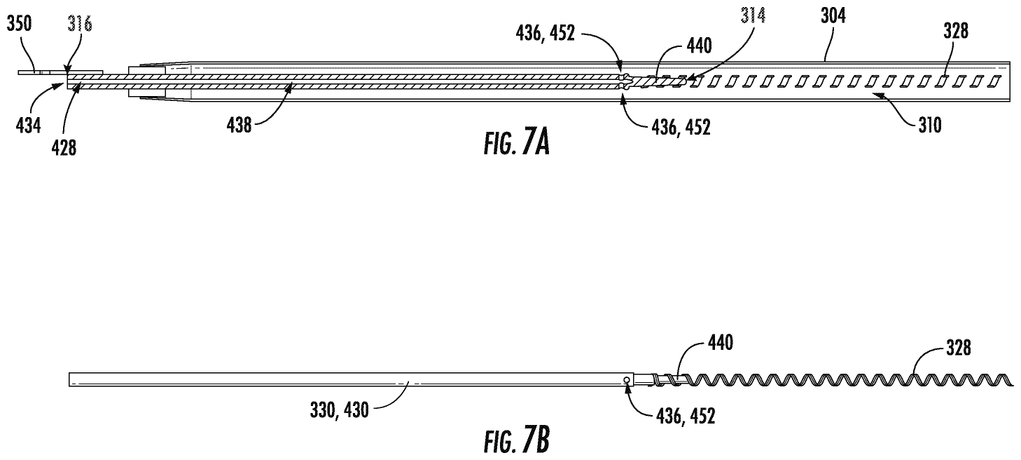

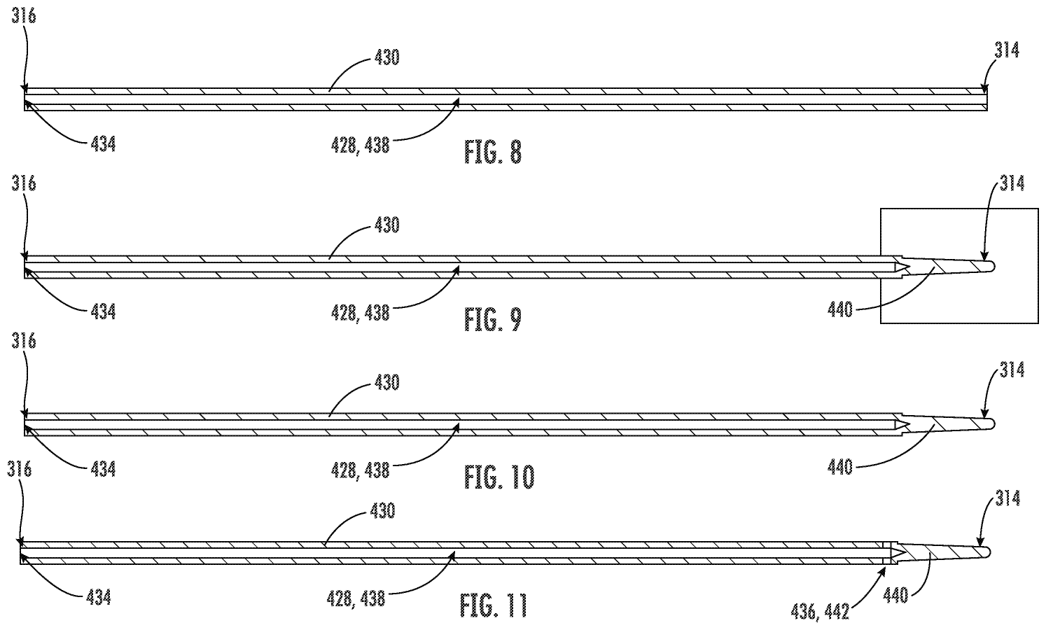

Turning now especially to FIGS. 8 through 11, formation of the solid tip 440 (e.g., as part of the assembly process for electric heating assembly 320) is generally illustrated. For instance, as illustrated at FIG. 8, tubular body 430 may originate as a hollow cylindrical, elliptical, or polygonal member having a continuous passage along the axial direction A (FIG. 5). As illustrated at FIG. 9, the solid tip 440 may subsequently be formed to close off or seal one end of the hollow cylindrical, elliptical, or polygonal member (e.g., via cold heading, hot forging, spin forming, or general machining processes, which are generally understood). The resulting member, which is illustrated at FIG. 10 may include only a single opening (e.g., vent outlet 434) leading to the longitudinal passage 438. Subsequently, vent inlet 436 may be formed, such as by drilling, laser cutting, or otherwise machining one or more openings (e.g., the radial entry passages 452-FIG. 7A) into a sidewall of the tubular body 430, as illustrated in FIG. 11. In optional embodiments, the vent inlet 436 may be subsequently temporarily sealed or covered, such as by one or more wax or cellulose plugs. Thus, during assembly, the insulation 334 (FIG. 5) may be supplied around the tubular body 430 without leaking into vent channel 428. The temporary seal or covering may then be destroyed (e.g., melted or burned) during an initial activation of the electric heating assembly, thereby opening vent inlet 436 to permit fluid communication of vapor through vent channel 428, as described above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An electric heating assembly for a consumer appliance, the electric heating assembly comprising:
a sheath defining an enclosed volume along a longitudinal length between a first end portion and a second end portion;
a resistive wire disposed within the enclosed volume to generate heat in response to an electrical current;
a thermally conductive electrical insulation radially positioned between the resistive wire and the sheath; and
a tubular body disposed radially inward from the sheath and defining a vent channel extending from a vent inlet disposed within the sheath to a vent outlet held outside of the sheath.

2. The electric heating assembly of claim 1, wherein the tubular body extends along an axial direction between a terminal internal end disposed within the sheath and a terminal external end held outside of the sheath, and
wherein the vent inlet is defined proximal to the terminal internal end relative to the axial direction.

3. The electric heating assembly of claim 1, wherein the tubular body extends longitudinally within the sheath as a cold pin of the electric heating assembly.

4. The electric heating assembly of claim 1, wherein the tubular body defines a plurality of radial entry passages in fluid communication with the vent inlet as at least a portion of the vent inlet.

5. The electric heating assembly of claim 4, wherein the vent outlet is defined as an axial aperture, coaxial with the vent inlet.

6. The electric heating assembly of claim 1, wherein the vent channel extends along an axial direction and thereby defines an axial channel length from the vent inlet to the vent outlet,
wherein the vent channel defines a minimum radial diameter within the tubular body, and
wherein the vent channel defines a channel ratio of the axial channel length over the minimum radial diameter that is between 50 and 1500.

7. The electric heating assembly of claim 6, wherein the minimum radial diameter is between approximately 0.01 and approximately 0.1 inches.

8. The electric heating assembly of claim 1, wherein a solid tip is formed on the tubular body across a longitudinal passage defining at least a portion of the vent channel.

9. The electric heating assembly of claim 8, wherein the solid tip is tapered, narrowing away from the vent channel.

10. The electric heating assembly of claim 8, wherein the resistive wire is attached to the tubular body at the solid tip.

11. An oven appliance, comprising:
a cabinet defining a cooking chamber for receiving food items for cooking; and
an electric heating assembly mounted within the cabinet, the electric heating assembly comprising
a sheath defining an enclosed volume along a longitudinal length between a first end portion and a second end portion,
a resistive wire disposed within the enclosed volume to generate heat in response to an electrical current,
a thermally conductive electrical insulation radially positioned between the resistive wire and the sheath, and
a tubular body disposed radially inward from the sheath and defining a vent channel extending from a vent inlet disposed within the sheath to a vent outlet held outside of the sheath.

12. The oven appliance of claim 11, wherein the tubular body extends along an axial direction between a terminal internal end disposed within the sheath and a terminal external end held outside of the sheath, and
wherein the vent inlet is defined proximal to the terminal internal end relative to the axial direction.

13. The oven appliance of claim 11, wherein the tubular body extends longitudinally within the sheath as a cold pin of the electric heating assembly.

14. The oven appliance of claim 11, wherein the tubular body defines a plurality of radial entry passages in fluid communication with the vent inlet as at least a portion of the vent inlet.

15. The oven appliance of claim 14, wherein the vent outlet is defined as an axial aperture, coaxial with the vent inlet.

16. The oven appliance of claim 11, wherein the vent channel extends along an axial direction and thereby defines an axial channel length from the vent inlet to the vent outlet,
wherein the vent channel defines a minimum radial diameter within the tubular body, and
wherein the vent channel defines a channel ratio of the axial channel length over the minimum radial diameter that is between 50 and 1500.

17. The oven appliance of claim 16, wherein the minimum radial diameter is between approximately 0.01 and approximately 0.1 inches.

18. The oven appliance of claim 11, wherein a solid tip is formed on the tubular body across a longitudinal passage defining at least a portion of the vent channel.

19. The oven appliance of claim 18, wherein the solid tip is tapered, narrowing away from the vent channel.

20. The oven appliance of claim 18, wherein the resistive wire is attached to the tubular body at the solid tip.
